(19) United States
(12) Patent Application Publication
(10) Pub. No.: US 2019/0042480 A1
(43) Pub. Date: Feb. 7, 2019

(54) METHOD FOR NON-VOLATILE MEMORY AND MEMORY CONTROLLER SECURED AND AUTHENTICATED PAIRING

(71) Applicant: Intel Corporation, Santa Clara, CA (US)

(72) Inventors: Amirali KHATIB ZADEH, Beaverton, OR (US); Pavel POLIAKOV, Cameron Park, CA (US); Shekoufeh QAWAMI, El Dorado Hills, CA (US)

(21) Appl. No.: 15/889,116

(22) Filed: Feb. 5, 2018

(51) Int. Cl. G06F 12/14; G11C 29/44; G06F 21/44

(52) U.S. Cl. CPC G06F 12/1458; G06F 2212/1052; G06F 21/44; G11C 29/44

(57) ABSTRACT

Examples include techniques for determining validity of a memory used with a memory controller. Examples include a system having a memory device including a non-volatile memory and a memory controller, where the memory controller includes a validation component including a hash function and a hash table. In embodiments, the validation component performs, during a time of manufacturing of the memory controller, a test of the non-volatile memory to produce first test results, generates a first hash of the first test results using the hash function, and stores the first hash in the hash table. Later, the validation component performs, during a time of use of the memory controller after the time of manufacturing, the test of the non-volatile memory to produce second test results, generates a second hash of the second test results using the hash function, compares the first hash from the hash table with the second hash, and indicates an invalid memory when the first hash does not match the second hash.

### TECHNICAL FIELD

Examples described herein are generally related to techniques for deterring the use of counterfeit non-volatile memories (NVMs) in computing platforms and solid-state storage devices (SSDs).

### BACKGROUND

In recent years some electronic component supply chains have become polluted by counterfeit NVMs. The negative effect of counterfeit NVMs is not limited to loss of revenue by the legitimate manufacturers but also extends to damage to their reputation and brand images. Various tests may be conducted in an attempt to combat the use of counterfeit products. Common practices after introduction of the “Specification for Authentication of Semiconductors and Related Products S. T20-1109” (available from SEMI at www.semi.org) in 2009 include mechanisms based on generating unpredictable and/or random codes which are applied at the package level. Such mechanisms typically require on-line access to a secure infrastructure to enable the legitimate manufacturer to validate the authenticity of devices. Requiring on-line access to a secure infrastructure is problematic in many product usage scenarios.

### BRIEF DESCRIPTION OF THE DRAWINGS

FIG. 1 illustrates an example memory controller and memory device arrangement.

FIG. 2 illustrates a first flow diagram.

FIG. 3 illustrates a mapping of raw bit error rate (RBER) to read reference voltage.

FIG. 4 illustrates a second flow diagram.

FIG. 5 illustrates an example pseudo code for a probe test.

FIG. 6 illustrates an example computing platform.

### DETAILED DESCRIPTION

As contemplated in the present disclosure, a non-volatile memory (NVM), such as a three-dimensional cross-point memory (e.g., a 3D XPoint™ memory commercially available from Intel Corporation), may be authenticated off-line using unique on-die characteristics. In embodiments of the present invention, authentication using intrinsic device-level characteristics may be applied, and a protocol for validating the authenticity of a NVM may be independent of any techniques for obfuscating NVM secret technology information. In an embodiment, the protocol is cost-effective and avoids extra hardware resources and/or on-line accessibility requirements. Embodiments of the present invention deter the unauthorized replacement of legitimate NVMs with counterfeit NVMs when used with legitimate memory controllers.

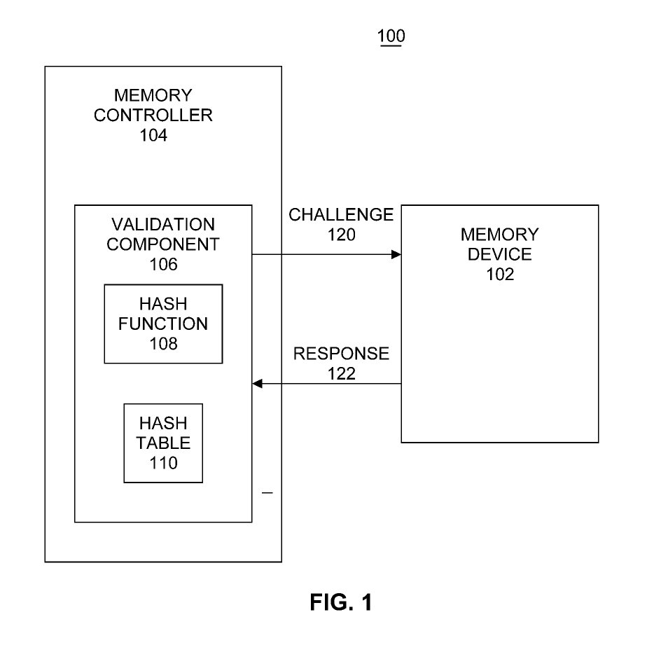

FIG. 1 illustrates an example memory controller and memory device arrangement 100. In some examples, as shown in FIG. 1, arrangement 100 includes a memory device 102 communicatively coupled to a memory controller 104. Memory device 102 may be an untrusted entity comprising a NVM die (not shown), functioning as the media for data storage. Memory controller 104 may be a trusted entity executing internal firmware and managing read and write operations with memory device 102.

In some examples, memory device 102 may include non-volatile types of memory, whose state is determinate even if power is interrupted. In some examples, memory device 102 may include non-volatile types of memory that is block addressable, such as for NAND or NOR technologies. Thus, memory device 102 can also include a future generation of types of NVM, such as a 3-dimensional cross-point memory (commercially available by Intel Corporation as 3D XPoint™), or other byte addressable non-volatile types of memory. According to some examples, memory device 102 may include types of NVM that includes chalcogenide glass, multi-threshold level NAND flash memory, NOR flash memory, single or multi-level Phase Change Memory (PCM), a resistive memory, nanowire memory, FeTRAM, MRAM that incorporates memristor technology, or STT-MRAM, or a combination of any of the above, or other memory.

However, examples are not limited in this manner, and in some instances memory device 102 may include volatile types of memory including, but not limited to, random access memory (RAM), D-RAM, DDR SDRAM, SRAM, T-RAM or Z-RAM. One example of volatile memory includes dynamic RAM (DRAM), or some variant such as SDRAM. A memory as described herein may be compatible with a number of memory technologies, such as HBM (HIGH BANDWIDTH MEMORY DRAM, JESD235, originally published by Joint Electron Device Engineering Council (JEDEC) Solid State Technology Association (JEDEC) in October 2013) and DDR5 (DDR version 5, currently in discussion by JEDEC), and/or others, and technologies based on derivatives, revisions, versions or extensions of such specifications.

Memory controller 104 may be arranged to control access to data at least temporarily stored at memory device 102. Although only one memory device is shown in the example of FIG. 1, it should be understood that in other examples multiple memory devices may be controlled by memory controller 104. In some examples, memory device 102 may be a solid-state memory device (SSD). In some examples, memory device 102 may be a Dual In-Line Memory Module (DIMM).

Memory controller 104 may include a validation component 106. Validation component may determine if memory device 102 is authorized to be used with memory controller 104 according to the examples discussed below. In embodiments, the validation component may be implemented within a processor or in a system on a chip (SOC). In at least some examples, memory controller and memory device arrangement 100 uses a challenge response protocol. Memory controller 104 may issue a challenge 120 to memory device 102, which responds with a response 122. Validation component 106 may include a hash function 108 for performing a cryptographic hash of a selected value as is well known. Hash table 110 may store a plurality of hash values, each hash value being associated with a memory device. In an embodiment, some or all of response 122 may be hashed by hash function 108 as part of the challenge response protocol to produce hash values stored in hash table 110. Although hash function 108 and hash table 110 are shown in FIG. 1 as being part of validation component 106, in other embodiments they may be separate components.

From a security perspective, embodiments of the present invention may be examples of implementations of Physical Unclonable Functions (PUFs). A physical unclonable function, or PUF, is a “digital fingerprint” that serves as a unique identity for a semiconductor device such as memory device 102. PUFs are based on physical variations which occur naturally during semiconductor manufacturing, and which make it possible to differentiate between otherwise identical semiconductors. PUFs depend on the uniqueness of their physical microstructure. This microstructure depends on random physical factors introduced during manufacturing. These factors are unpredictable and uncontrollable, which makes it virtually impossible to duplicate or clone the structure. Rather than embodying a single cryptographic key, PUFs implement challenge-response authentication to evaluate this microstructure. When a physical stimulus is applied to the structure, it reacts in an unpredictable (but repeatable) way due to the complex interaction of the stimulus with the physical microstructure of the device. This exact microstructure depends on physical factors introduced during manufacture which are unpredictable. The applied stimulus is called the challenge, and the reaction of the PUF is called the response. A specific challenge and its corresponding response together form a challenge-response pair or CRP. The device's identity is established by the properties of the microstructure itself. As this structure is not directly revealed by the challenge-response mechanism, such a device is resistant to spoofing attacks. Using a key extractor, PUFs can also be used to extract a unique strong cryptographic key from the physical microstructure. The same unique key is reconstructed every time the PUF is evaluated. The challenge-response mechanism may then be implemented using known cryptographic methods.

In embodiments of the present invention, PUFs can be implemented with a very small hardware investment. Unlike a read only memory (ROM) containing a table of responses to all possible challenges, which would require hardware exponential in the number of challenge bits, a PUF can be constructed in hardware proportional to the number of challenge and response bits. A PUF's operation is initiated by a trusted entity (e.g., memory controller 104) sending out a challenge to another entity (e.g., memory device 102) that is subject to authenticity validation, and the response from the latter entity is compared against the results stored in trusted entity.

Unclonability means that each PUF device (i.e., a memory device) has a unique and unpredictable way of mapping challenges to responses, even if it was manufactured with the same process as a similar device, and it is infeasible to construct a PUF with the same challenge-response behavior as another given PUF because exact control over the manufacturing process is infeasible. Mathematical unclonability means that it should be very hard to compute an unknown response given the other CRPs or some of the properties of the random components from a PUF. This is because a response is created by a complex interaction of the challenge with many or all of the random components. In other words, given the design of the PUF system, without knowing all of the physical properties of the random components, the CRPs are highly unpredictable. The combination of physical and mathematical unclonability renders a PUF truly unclonable. Because of these properties PUB can be used as a unique and un-tamperable device identifier.

Embodiments of the present invention utilize these PUF concepts such that the memory controller (i.e., the trusted entity) utilizes the NVM die-specific characteristics which are gathered during a “Probe test” at a manufacturing facility. A Probe test is typically done at wafer level testing at a manufacturing facility, with the aim of detecting bad dies in a chip, and repairing the bad dies if possible with redundant elements. The memory controller executes the Probe test on-the-fly. If the memory device (i.e., the untrusted entity) has not been swapped since it was paired with the memory controller in a trusted environment (for example, as part of the manufacturing and/or testing process), the memory controller expects no differences between the results of the on-the-fly and the initial Probe tests; otherwise, the memory controller detects a NVM replacement.

In an embodiment, each NVM die in memory device 102 manufactured at a trusted manufacturing facility may get characterized by executing a Probe test and one or more of the die's parameters, for example a Demarcation Voltage (V_{DM}), may be trimmed by die (“TBD”). TBD in this context refers to blowing unique fuse values based on a known “Shmoos” test to obtain a lower Raw Bit Error Rate (RBER) for the die by compensating for error variability. During a Shmoos test, a parameter is swept through an allowed span of values. These characteristics are unique per die and per fabrication process. In an embodiment, every die may contain approximately 20 TBD unique parameters.

Embodiments of the present invention modify one or more of these TBD parameters, and execute a Probe test flow “on-the-fly”. Embodiments of the present invention compare the results of “on-the-fly” Probe test flow with information previously gathered during the manufacturing process to validate the memory device. In one embodiment, computation of RBER may be used as an example of a manufacturing Probe test (i.e., the PUF), however in other embodiments, other Probe tests using other TBD parameters may be used.

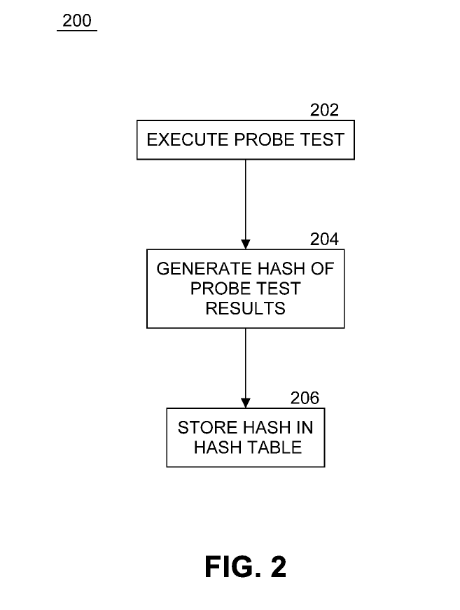

FIG. 2 illustrates a first flow diagram of generating test results during manufacturing. In an embodiment, flow 200 may be performed by memory controller 104 during the manufacturing or testing process in a trusted manufacturing facility. At block 202, memory controller executes a Probe test on memory device 102. In an embodiment, the probe test may comprise running a plurality of write and subsequent read tests on the memory device and measuring a correlation of a RBER to a read reference voltage (RRV), also known as Demarcation Voltage (Vdm). The memory controller may generate a cryptographic hash of the Probe test results, using hash function 108 of validation component 106 at block 204. Any suitable cryptographic hash function may be used. At block 206, the memory controller may store the hash in hash table 110. Use of hash values may be important for security. If the hash values were subsequently exposed to untrusted parties, the hash values do not provide any details of underlying memory device or memory controller technology, nor allow an adversary to reverse engineer the challenge/response protocol of embodiments of the present invention. In an embodiment, storage of the hash value in the hash table in the memory controller may be performed by executing a firmware management program operating in the manufacturing or data center environment that provides the capability for the memory controller firmware to be updated.

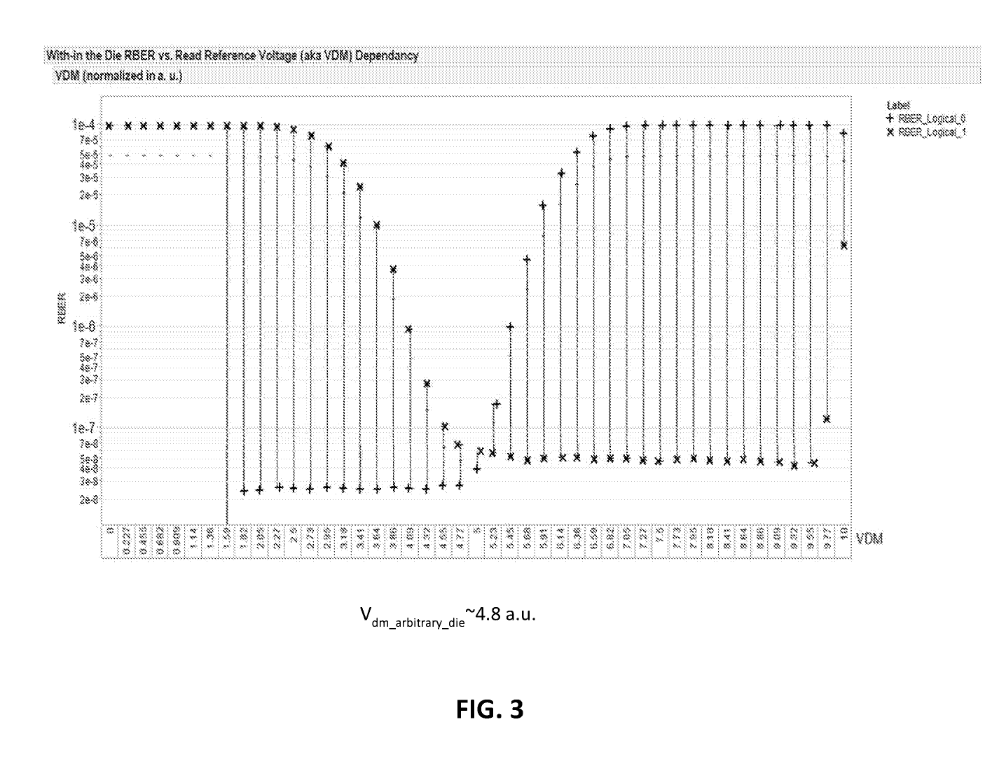

FIG. 3 illustrates a mapping of raw bit error rate (RBER) to read reference voltage (RRV) according to one embodiment. The probe test results such as RBER versus Demarcation Voltage (Vdm) are expected to be unique per die. Therefore, the memory controller will be able to identify an unauthentic or replaced memory device if the memory controller determines that the results of an on-the-fly Probe test do not match the stored results. FIG. 3 presents the Shmoo collected TBD Vdm (equivalent to read reference voltage, which may be used for differentiating between stored logical “1” and “0”). Every die per wafer (even per lot) will be trimmed (e.g., tuned) with the unique TBD value in order to compensate for the “natural” fabrication processing induced variability. FIG. 3 presents only the averaged data; in this example 4.8 a.u. (in arbitrary units) is shown to have lowest RBER. The same statistically processed value will be provisioned on the memory controller by performing a hashing operation.

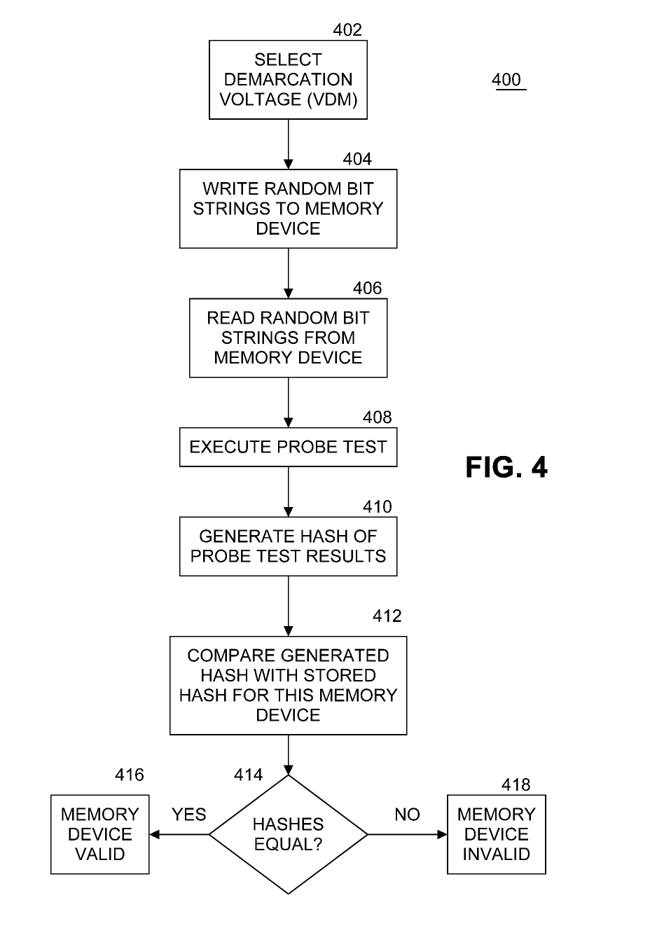

FIG. 4 illustrates a second flow diagram. In an embodiment, flow 400 may be performed by memory controller 104 to validate the authenticity of memory device 102. This validation may be performed at any time after the memory controller is manufactured and the steps of process 200 have been performed. In one example, the validation process may be performed at startup time of a computing platform wherein the memory controller and memory device are installed. In another example, the validation may be performed periodically or randomly while the computing platform is operating. At block 402, memory controller may select a demarcation voltage (Vdm), which is selected in the same manner as the Probe Shmoo test does. At block 404, memory controller 104 writes a random bit string to spatially distributed addresses within memory device 102. The random bit string data can be any pseudo random data generated with equal number of 1s and 0s. The random string may be generated by the memory controller 104. The addresses (or the address span) will be the same as at the Probe level. In an embodiment, block 404 is the challenge in the challenge response protocol. In one example, the string has a length of greater than 1024 bits, although in other examples, other lengths may be used. The length of the string determines the security level, which is a measure of the strength that a cryptographic primitive achieves. In one embodiment, the value of 1024 may be used since it is expected to provide a sufficient level of security. The length of the string can vary based on desired level of security. In an embodiment, the write operation is performed in the way that the RBER requires. The exact Probe level test will be executed by the memory controller, in order to obtain a good cross-match between provisioned data and the “on-the-fly” collected data. At block 406, the memory controller reads the random bit string back from the spatially distributed addresses within the memory device. This is the response in the challenge response protocol. In embodiments, the response must be easy to generate and close to impossible to duplicate (even for an instance of the same memory controller with another memory device).

Upon receiving the random bit string back from the memory device, the memory controller executes the Probe test at block 408 to determine the RBER (e.g., counts of the bit errors during the read operation without applying any Error Correction Code (ECC)). In an embodiment, the RBER comprises the Probe test results. In other embodiments, block 404 and 406 may be performed as part of the Probe test at block 408. The RBER will be calculated as it is shown on the y-axis of FIG. 3. In an embodiment, one purpose of determining RBER at fabrication time is to determine the optimal value of Vdm. By sweeping biasing parameters (i.e., Wordline and Bitline Voltage), the Vdm gets regulated for the least RBER (as shown above in FIG. 3). At block 410, the memory controller generates a cryptographic hash of the probe test results. At block 412, the memory controller compares the newly generated hash value as a result of executing the challenge response protocol with the memory device 102 with the hash value for this memory device previously stored in the hash table 110 of the memory controller 104 at manufacturing time. If at block 414 the hashes are equal, the memory device is determined to be valid at block 416. If at block 414 the hashes are not equal, the memory device is determined to be invalid at block 418. If the memory device is invalid, it may be presumed that an authorized memory device has been swapped with an unauthorized memory device.

Embodiments of the present invention use NVM die-specific information and the probe test flow to validate the authenticity of memory devices. An advantage of the presently disclosed embodiments is that it does not require any additional hardware resources, nor on-line communication capabilities. Embodiments utilize pre-existing memory device and memory controller hardware, and already available probe test results determined during the manufacturing process.

In embodiments, firmware in memory controller 104 may be sufficient for executing the challenge response protocol described herein and the associated validation. The amount of memory required for storing the post fabrication probe test results in the memory controller is insignificant. Further, embodiments of the present invention do not require any additional hardware and/or software resources to be added to the memory device.

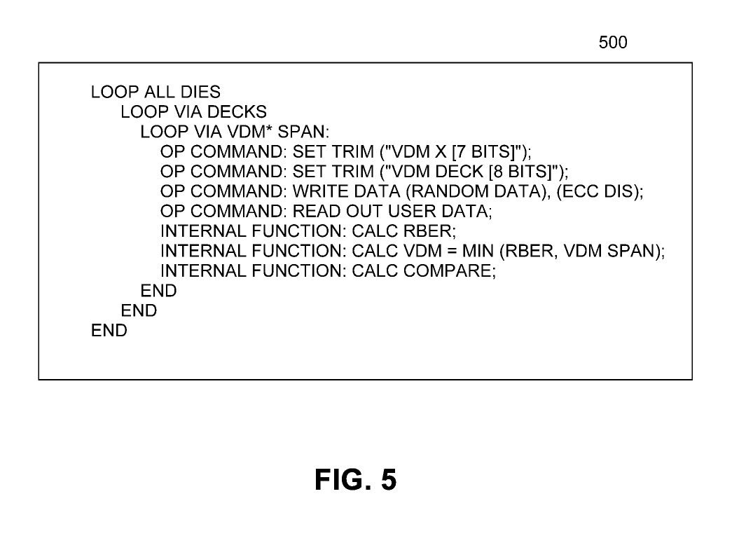

FIG. 5 illustrates an example pseudo code 500 for a probe test. In an embodiment, this pseudo code may be used to compute RBER for determining the Vdm value in a memory device. The simplified Pseudo code is valid for 3D NAND and 3D Xpoint memory products, where the internal Vdm (e.g., Read Reference voltage) is swept over the allowed range, data is written and then read, the RBER (Random Bit Error Rate, i.e., the number of failures) is calculated and then compared to provisioned Probe data by iterating over all dies and 3D stacks.

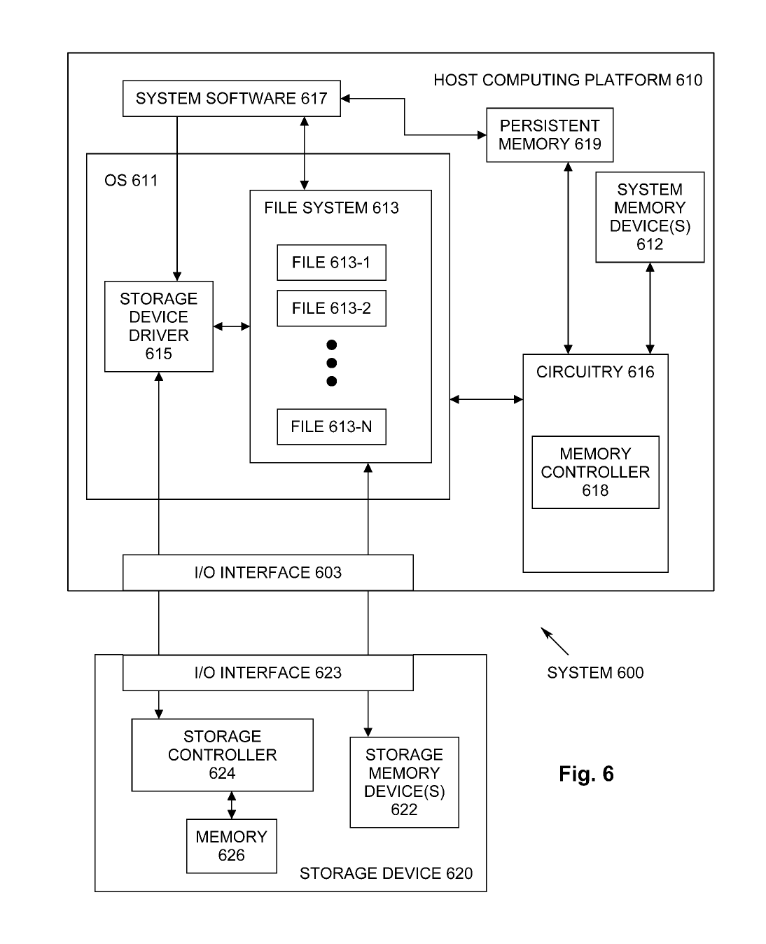

FIG. 6 illustrates an example computing platform 600. In some examples, embodiments of the present invention may be applied to validate the authenticity of various components that function as memory devices 102, such as system memory device(s) 612, persistent memory 619, memory 626, and/or storage memory device(s) 122. In some examples, as shown in FIG. 6, system 600 includes a host computing platform 610 coupled to one or more storage device(s) 620 through I/O interface 603 and I/O interface 623. Also, as shown in FIG. 6, host computing platform 610 may include an OS 611, one or more system memory device(s) 612, circuitry 616 and system software 617. For these examples, circuitry 616 may be capable of executing various functional elements of host computing platform 610 such as OS 611 and system software 617 that may be maintained, at least in part, within system memory device(s) 612. Circuitry 616 may include host processing circuitry to include one or more central processing units (CPUs) (not shown) and associated chipsets and/or memory controllers 618.

According to some examples, as shown in FIG. 6, OS 111 may include a file system 613 and a storage device driver 615 and storage device 620 may include a storage controller 624 (analogous to memory controller 104 of FIG. 1), one or more storage memory device(s) 622 and memory 626. OS 611 may be arranged to implement storage device driver 615 to coordinate at least temporary storage of data for a file from among files 613-1 to 613-n, where “n” is any whole positive integer >1, to storage memory device(s) 622. The data, for example, may have originated from or may be associated with executing at least portions of system software 617 and/or OS 611, or application programs (not shown in FIG. 6). As described in more detail below, OS 611 communicates one or more commands and transactions with storage device 620 to write data to storage device 620. The commands and transactions may be organized and processed by logic and/or features at the storage device 620 to write the data to storage device 620.

In some examples, storage controller 624 may include logic and/or features to receive a read or write transaction request to storage memory device(s) 622 at storage device 120. For these examples, the transactions may be initiated by or sourced from system software 617 that may, in some embodiments, utilize file system 613 to write data to storage device 620 through input/output (I/O) interfaces 603 and 623. In an embodiment, storage controller 624 may validate storage memory device(s) 622 as discussed with reference to FIGS. 1 through 4.

In some examples, storage memory device(s) 622 may be a device to store data from read and write transactions and/or read and write operations. Storage memory device(s) 622 may include one or more chips or dies having gates that may individually include one or more types of non-volatile memory to include, but not limited to, NAND flash memory, NOR flash memory, 3-D cross-point memory (3D XPoint™), ferroelectric memory, SONOS memory, ferroelectric polymer memory, FeTRAM, FeRAM, ovonic memory, nanowire, EEPROM, phase change memory, memristors or STT-MRAM. For these examples, storage device 620 may be arranged or configured as a solid-state drive (SSD). The data may be read and written in blocks and a mapping or location information for the blocks may be kept in memory 626.

According to some examples, communications between storage device driver 615 and storage controller 624 for data stored in storage memory devices(s) 622 and accessed via files 613-1 to 613-n may be routed through I/O interface 603 and I/O interface 623. I/O interfaces 603 and 623 may be arranged as a Serial Advanced Technology Attachment (SATA) interface to couple elements of host computing platform 610 to storage device 620. In another example, I/O interfaces 603 and 623 may be arranged as a Serial Attached Small Computer System Interface (SCSI) (or simply SAS) interface to couple elements of host computing platform 610 to storage device 620. In another example, I/O interfaces 603 and 623 may be arranged as a Peripheral Component Interconnect Express (PCIe) interface to couple elements of host computing platform 610 to storage device 620. In another example, I/O interfaces 603 and 623 may be arranged as a Non-Volatile Memory Express (NVMe) interface to couple elements of host computing platform 610 to storage device 620. For this other example, communication protocols may be utilized to communicate through I/O interfaces 603 and 623 as described in industry standards or specifications (including progenies or variants) such as the Peripheral Component Interconnect (PCI) Express Base Specification, revision 3.1, published in November 2014 (“PCI Express specification” or “PCIe specification”) or later revisions, and/or the Non-Volatile Memory Express (NVMe) Specification, revision 1.2, also published in November 2014 (“NVMe specification”) or later revisions.

In some examples, system memory device(s) 612 may store information and commands which may be used by circuitry 616 for processing information. Also, as shown in FIG. 6, circuitry 616 may include a memory controller 618. Memory controller 618 may be arranged to control access to data at least temporarily stored at system memory device(s) 612 for eventual storage to storage memory device(s) 622 at storage device 620. In an embodiment, memory controller 618 may validate system memory device(s) 612 or persistent memory 619 as discussed with reference to FIGS. 1 through 4.

In some examples, storage device driver 615 may include logic and/or features to forward commands associated with one or more read or write transactions and/or read or write operations originating from system software 617. For example, the storage device driver 615 may forward commands associated with write transactions such that data may be caused to be stored to storage memory device(s) 622 at storage device 620. More specifically, storage device driver 615 can enable communication of the write operations from system software 617 at computing platform 610 to controller 624.

System Memory device(s) 612 may include one or more chips or dies having volatile types of memory such RAM, D-RAM, DDR SDRAM, SRAM, T-RAM or Z-RAM. However, examples are not limited in this manner, and in some instances, system memory device(s) 612 may include non-volatile types of memory, including, but not limited to, NAND flash memory, NOR flash memory, 3-D cross-point memory (3D XPoint™), ferroelectric memory, SONOS memory, ferroelectric polymer memory, FeTRAM, FeRAM, ovonic memory, nanowire, EEPROM, phase change memory, memristors or STT-MRAM.

Persistent memory 619 may include one or more chips or dies having non-volatile types of memory, including, but not limited to, NAND flash memory, NOR flash memory, 3-D cross-point memory (3D XPoint™), ferroelectric memory, SONOS memory, ferroelectric polymer memory, FeTRAM, FeRAM, ovonic memory, nanowire, EEPROM, phase change memory, memristors or STT-MRAM.

According to some examples, host computing platform 610 may include, but is not limited to, a server, a server array or server farm, a web server, a network server, an Internet server, a work station, a mini-computer, a main frame computer, a supercomputer, a network appliance, a web appliance, a distributed computing system, a personal computer, a tablet computer, a smart phone, multiprocessor systems, processor-based systems, or combination thereof.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one storage medium such as a non-transitory computer readable medium or machine readable medium, e.g., an optical, magnetic or semiconductor storage.

Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

According to some examples, a component called circuitry 616 of FIG. 5 may execute processing operations or logic for memory controller 104 or 618. Circuitry 616 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, ASIC, programmable logic devices (PLD), digital signal processors (DSP), FPGA/programmable logic, memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software components, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

Host computing platform 610 may be part of a computing device that may be, for example, user equipment, a computer, a personal computer (PC), a desktop computer, a laptop computer, a notebook computer, a netbook computer, a tablet, a smart phone, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of host computing platform 110 described herein, may be included or omitted in various embodiments of host computing platform 110, as suitably desired.

The components and features of host computing platform 610 may be implemented using any combination of discrete circuitry, ASICs, logic gates and/or single chip architectures. Further, the features of host computing platform 610 may be implemented using microcontrollers, programmable logic arrays and/or microprocessors or any combination of the foregoing where suitably appropriate. It is noted that hardware, firmware and/or software elements may be collectively or individually referred to herein as “logic”, “circuit” or “circuitry.”

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus coupled to a memory comprising:
a validation component comprising a hash function and a hash table, the validation component to perform, during a time of manufacturing of the apparatus, a test of the memory to produce first test results, to generate a first hash of the first test results using the hash function, and to store the first hash in the hash table, and to perform, during a time of use of the apparatus after the time of manufacturing, the test of the memory to produce second test results, to generate a second hash of the second test results using the hash function, to compare the first hash from the hash table with the second hash, and to indicate an invalid memory when the first hash does not match the second hash.

2. The apparatus of claim 1, wherein the test comprises a physical unclonable function (PUF).

3. The apparatus of claim 2, wherein the PUF comprises a raw bit error rate (RBER) of a demarcation voltage of the memory.

4. The apparatus of claim 3, wherein the apparatus is configured to perform the test by writing random bit strings to the memory and reading the random bit strings out of the memory and calculating RBER of the memory during a time of use of the apparatus after the time of manufacturing.

5. The apparatus of claim 1, wherein the apparatus comprises a trusted entity and the memory comprises an untrusted entity.

6. The apparatus of claim 1, wherein the apparatus comprises a memory controller and the validation component comprises executable firmware stored in the memory controller.

7. A method comprising:
performing, during a time of manufacturing of an apparatus coupled to a memory, the apparatus comprising a validation component including a hash function and a hash table, a test of the memory to produce first test results,
generating a first hash of the first test results using the hash function, and
storing the first hash in the hash table; and
performing, during a time of use of the apparatus after the time of manufacturing, the test of the memory to produce second test results,
generating a second hash of the second test results using the hash function,
comparing the first hash from the hash table with the second hash, and
indicating an invalid memory when the first hash does not match the second hash.

8. The method of claim 7, wherein the test comprises a physical unclonable function (PUF).

9. The method of claim 8, wherein the PUF comprises a raw bit error rate (RBER) of a demarcation voltage of the memory.

10. The method of claim 9, wherein performing the test comprises performing the test by writing random bit strings to the memory and reading the random bit strings out of the memory and calculating RBER of the memory during a time of use of the apparatus after the time of manufacturing.

11. The method of claim 7, wherein the apparatus comprises a trusted entity and the memory comprises an untrusted entity.

12. The method of claim 7, wherein the apparatus comprises a memory controller and the validation component comprises executable firmware stored in the memory controller.

13. At least one machine readable medium comprising a plurality of instructions that in response to being executed by an apparatus of a computing system cause the apparatus to:
perform, during a time of manufacturing of the apparatus coupled to a memory, the apparatus comprising a validation component including a hash function and a hash table, a test of the memory to produce first test results,
generate a first hash of the first test results using the hash function, and
store the first hash in the hash table; and
perform, during a time of use of the apparatus after the time of manufacturing, the test of the memory to produce second test results,
generate a second hash of the second test results using the hash function,
compare the first hash from the hash table with the second hash, and
indicate an invalid memory when the first hash does not match the second hash.

14. The at least one machine readable medium of claim 13, wherein the test comprises a physical unclonable function (PUF).

15. The at least one machine readable of claim 14, wherein the PUF comprises a raw bit error rate (RBER) of a demarcation voltage of the memory.

16. The at least one machine readable of claim 15, wherein instructions to perform the test comprises instructions to perform the test by writing random bit strings to the memory and reading the random bit strings out of the memory and calculating RBER of the memory during a time of use of the apparatus after the time of manufacturing.

17. A system comprising:
a memory device including a non-volatile memory; and
a memory controller, coupled to the memory device, comprising
a validation component including a hash function and a hash table, the validation component to perform, during a time of manufacturing of the memory controller, a test of the non-volatile memory to produce first test results, to generate a first hash of the first test results using the hash function, and to store the first hash in the hash table, and to perform, during a time of use of the memory controller after the time of manufacturing, the test of the non-volatile memory to produce second test results, to generate a second hash of the second test results using the hash function, to compare the first hash from the hash table with the second hash, and to indicate an invalid memory when the first hash does not match the second hash.

18. The system of claim 17, wherein the test comprises a physical unclonable function (PUF).

19. The system of claim 18, wherein the PUF comprises a raw bit error rate (RBER) of a demarcation voltage of the memory.

20. The system of claim 19, wherein the memory controller is configured to perform the test by writing random bit strings to the non-volatile memory and reading the random bit strings out of the non-volatile memory and calculating RBER of the non-volatile memory during a time of use of the apparatus after the time of manufacturing.

21. The system of claim 20, wherein a size of the random bit strings comprises at least 1024 bits.

22. The system of claim 17, wherein the memory controller comprises a trusted entity and the memory device comprises an untrusted entity.

23. The system of claim 17, wherein the non-volatile memory comprises a 3-dimensional cross-point memory.

24. The system of claim 19, wherein the demarcation voltage is trimmed by die (TBD) during a time of manufacturing of the memory controller by blowing unique fuse values of the non-volatile memory based on a Shmoos test to obtain a lower RBER for the non-volatile memory.

25. A processor, coupled to a non-volatile memory device, comprising:
a memory controller including a hash function and a hash table, the memory controller to perform, during a time of manufacturing of the processor, a test of the non-volatile memory device to produce first test results, to generate a first hash of the first test results using the hash function, and to store the first hash in the hash table, and to perform, during a time of use of the processor after the time of manufacturing, the test of the non-volatile memory device to produce second test results, to generate a second hash of the second test results using the hash function, to compare the first hash from the hash table with the second hash, and to indicate an invalid memory when the first hash does not match the second hash.

26. The processor of claim 25, wherein the test comprises a physical unclonable function (PUF).

27. The processor of claim 26, wherein the PUF comprises a raw bit error rate (RBER) of a demarcation voltage of the non-volatile memory device.

28. The processor of claim 27, wherein the memory controller is configured to perform the test by writing random bit strings to the non-volatile memory and reading the random bit strings out of the non-volatile memory and calculating RBER of the non-volatile memory during a time of use of the apparatus after the time of manufacturing.

29. The processer of claim 25, wherein the memory controller comprises a trusted entity and the non-volatile memory device comprises an untrusted entity.

30. The processor of claim 27, wherein the demarcation voltage is trimmed by die (TBD) during a time of manufacturing of the memory controller by blowing unique fuse values of the non-volatile memory based on a Shmoos test to obtain a lower RBER for the non-volatile memory.
